(19) United States
(12) Patent Application Publication
(10) Pub. No.: US 2020/0024185 A1
(43) Pub. Date: Jan. 23, 2020

(54) Laminated System

(71) Applicant: KCC Corporation, Seoul (KR)

(72) Inventors: Hyoun Joo Lee, Busanjin-gu, Busan (KR); Hyun Min Kang, Suwon-si, Gyeonggi-do (KR); Jin Yong Kim, Suwon-si, Gyeonggi-do (KR); Young Hoon Oh, Seoul (KR)

(73) Assignee: KCC Corporation, Seoul (KR)

(21) Appl. No.: 16/499,336

(22) PCT Filed: Apr. 17, 2018
(86) PCT No.: PCT/KR2018/004449

§ 371 Date: Sep. 30, 2019

(30) Foreign Application Priority Data
Apr. 17, 2017 (KR) 10-2017-0049003

(51) Int. Cl. C03C 17/23

(52) U.S. Cl. CPC C03C 17/23; C03C 2218/152; C03C 2217/212; C03C 2217/216; C03C 2217/211; C03C 2217/22; C03C 2217/281; C03C 2217/29; C03C 2217/285; C03C 2217/218; C03C 2217/219; C03C 2217/734; C03C 2218/154; C03C 2218/151; C03C 2217/214

(57) ABSTRACT

The present invention provides a lamination system comprising a substrate and a highly reflective layer, which is formed on the substrate and has a reflective index of 2.0 or greater and a thickness of 70 nm or less.

### TECHNICAL FIELD

The present invention relates to a laminated system.

### BACKGROUND ART

Recently, mobile devices such as smart phones, tablet PCs, etc. have rapidly propagated, and thus, consumers' requirements are becoming more advanced. Particularly, from software to hardware, such devices are evolving day by day to meet those requirements.

As one of the advanced strategies, in the case of hardware, the screen becomes larger, and through the addition of design elements, each manufacturer takes an advanced strategy to build a unique image.

In general, as the mobile devices have much contact with various external environments as well as users' hands, they functionally require not only excellent corrosion resistance and wear resistance but also considerable surface hardness and strength and excellent adhesion, and in terms of appearance, for such devices, high-quality color expression are very important as well as excellent surface texture.

Various chemical and physical coating methods applied to a substrate for high-quality color expression are known. For example, a color coating method using an inorganic pigment dispersed in a polyester resin, a color expressing method on the surface of a substrate using ITO through a vacuum deposition method, and a coating method by coating the surface of a substrate with a thin film through PVD and changing a color by injecting a metal ion or gas ion ionized using an ion injection method have been studied.

However, as a method of expressing the most diverse colors, anodizing may be used, but this method is disadvantageous in that used materials are expensive and there is no high-quality color or transparency required in the emotional age.

Therefore, technology that utilizes a transparent substrate as it is and imparts luxury by implementing ceramic-like deep and soft colors, which is a new trend, is required, and such technology may be applied in various fields as well as mobile devices. For example, there is a demand for technology that can be used for electronic devices including a display panel, and impart luxury by implementing deep and soft colors in various fields such as furniture and home appliances.

(Patent Document 1) Korean Unexamined Patent Application Publication No. 2014-0138467

### DISCLOSURE

### Technical Problem

The present invention is directed to providing a high-reflection laminated system.

### Technical Solution

In one aspect, the present invention provides a laminated system including a substrate, and a high refractive index layer having a reflective index of 2.0 or more and a thickness of 70 nm or less, which is formed on the substrate.

### Advantageous Effects

Since a laminated system according to an exemplary embodiment of the present invention can exhibit transparency, a soft color and a reflection effect, when the laminated system according to the present invention is applied, it is possible to realize a substrate having a deep and soft color with a ceramic texture and/or a high quality texture.

### DESCRIPTION OF DRAWINGS

The following drawings accompanying the specification are provided to illustrate preferable embodiments of the present invention and to promote further understanding of the technical spirit of the present invention with the above-described contents of the present invention, and therefore, the present invention should not be construed as being limited to only the details shown in these drawings.

FIG. 1 is a schematic diagram of a single-layered laminated system 100, which includes a high refractive index layer 120 on a substrate 110 according to an exemplary embodiment of the present invention.

FIG. 2 is a schematic diagram of a bi-layered laminated system 200, which sequentially includes a high refractive index layer 220 and a low refractive index layer 230 on a substrate 210 according to an exemplary embodiment of the present invention.

FIG. 3 is a schematic diagram of a tri-layered laminated system 300, which sequentially includes a high refractive index layer 320, a low refractive index layer 330 and a high refractive index layer 340 on a substrate 310 according to an exemplary embodiment of the present invention.

FIG. 4 is a schematic diagram of an example of a structure which includes a laminated system 400, a primer layer 410 and an anti-fingerprint coating film 420 according to an exemplary embodiment of the present invention.

FIG. 5 is a schematic diagram of an example of a structure which includes a paint coating layer 530, a laminated system 500, a primer layer 510, and an anti-fingerprint coating film 520 according to an exemplary embodiment of the present invention.

Reference numerals used in the drawings attached to the specification indicate the following:
100, 200, 300, 400, 500: laminated system
110, 210, 310: glass substrate
120, 220, 320, 340: high refractive index layer
230, 330: low refractive index layer
410, 510: primer layer (SiO₂)
420, 520: anti-fingerprint coating film
530: paint coating layer

### MODES OF THE INVENTION

Hereinafter, embodiments will be described in further detail to help in understanding the present invention.

Terms and words used in the specification and claims should not be construed as limited to general or dictionary meanings, and should be interpreted with the meaning and concept in accordance with the technical idea of the present invention based on the principle that the inventors have appropriately defined the concepts of terms in order to explain the invention in the best way.

A laminated system according to an exemplary embodiment of the present invention includes a substrate, and a high refractive index layer having a refractive index of 2.0 or more and a thickness of 70 nm or less, formed on the substrate.

The laminated system according to an exemplary embodiment of the present invention includes a high refractive index layer having a refractive index of 2.0 or more and a thickness of 70 nm or less, formed on a substrate, thereby exhibiting transparency, a soft color and a reflection effect, and thus imparting a deep and soft color with a ceramic texture or a luxurious texture to the substrate.

Hereinafter, the present invention will be described in detail.

According to an exemplary embodiment of the present invention, the laminated system may include a substrate, and the substrate may include both of a transparent substrate and an opaque substrate, which are specifically formed of glass, polyethylene terephthalate (PET), a high-gloss coated material (also called high glossy), a metal or glass/PET. The refractive index of the substrate may be, for example, 1.50 to 1.52, but the present invention is not limited thereto. The thickness of the substrate may be, for example, 0.3 to 6 mm, but the present invention is not limited thereto.

In addition, according to an exemplary embodiment of the present invention, the laminated system may include a high refractive index layer having a refractive index of 2.0 or more and a thickness of 70 nm or less, formed on the substrate.

Specifically, in the laminated system, the refractive index of the high refractive index layer is 2.0 or more, and more specifically, 2.0 to 3.0, and when the refractive index of the high refractive index layer is within the above range, in the present invention, the desired soft and diverse colors and reflection effect may be excellently realized. In the present invention, the refractive index may be measured using, for example, ellipsometer equipment, but the present invention is not limited thereto.

In addition, the thickness of the high refractive index layer may be 70 nm or less, specifically, 3 to 70 nm, and more specifically, 3 to 60 nm. The laminated system may have reflectance at its surface or coating surface, which varies according to the thickness of the high refractive index layer, and thus a color and sense of depth may be changed. When the thickness of the high refractive index layer is more than 70 nm, the desired reflectance or color in the present invention may not be realized, and therefore a high-quality color or transparency may be degraded.

The realized laminated system may have various structures including a substrate and a high refractive index layer.

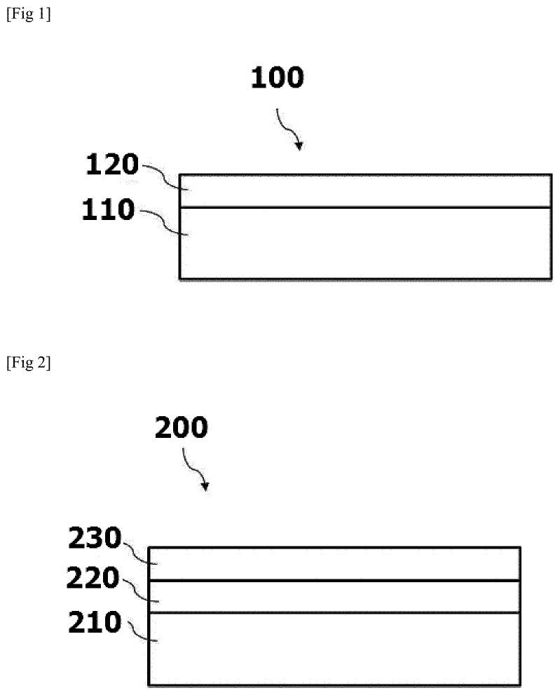

Specifically, a laminated system 100 according to an exemplary embodiment of the present invention may be a single-layered system including, as shown in FIG. 1, a substrate 110, and a high refractive index layer 120 formed on the substrate 110.

According to another exemplary embodiment of the present invention, the laminated system may be a multi-layered system, which includes a high refractive index layer formed on a substrate, and further includes a low refractive index layer, which is formed on the high refractive index layer and has a lower refractive index than the high refractive index layer. That is, the laminated system may include the high refractive index layer, the low refractive index layer, or a multi-layered coating layer in which two or more such refractive layers are repeatedly stacked.

A laminated system 200 according to an exemplary embodiment of the present invention may include, as shown in FIG. 2, a substrate 210, a high refractive index layer 220 formed on the substrate 210, and a low refractive index layer 230 formed on the high refractive index layer 220.

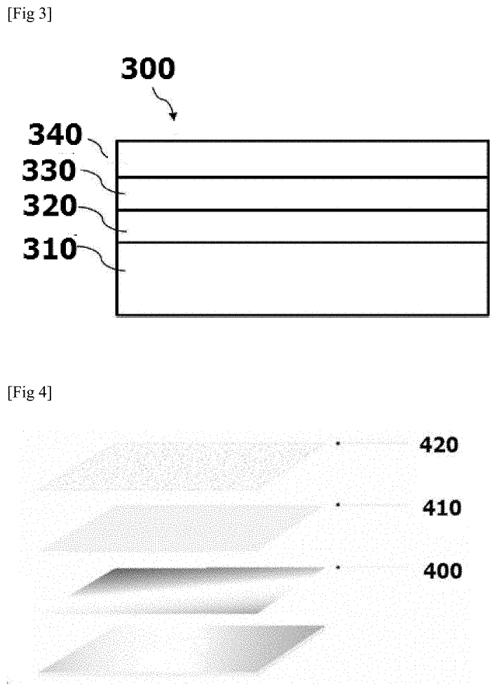

In addition, a laminated system 300 according to an exemplary embodiment of the present invention may include, as shown in FIG. 3, a substrate 310, a high refractive index layer 320 formed on the substrate 310, a low refractive index layer 330 formed on the high refractive index layer 320, and a high refractive index layer 340 formed on the low refractive index layer 330, which are sequentially laminated.

In addition, a laminated system according to still another exemplary embodiment of the present invention may include a high refractive index layer, a low refractive index layer, a high refractive index layer, a low refractive index layer and a high refractive index layer, which are sequentially stacked on a substrate.

In the laminated system, a repeated stacking number of the high refractive index layer and the low refractive index layer may be variously changed according to a desired design or desired performance without inhibiting the effect of the present invention.

In addition, when the laminated system includes a multi-layered coating layer, the outermost layer of the multi-layered coating layer may be a low refractive index layer or a high refractive index layer, and preferably, a high refractive index layer to realize a desired reflectance and color in the present invention, but the present invention is not limited thereto.

The low refractive index layer may have, for example, a refractive index of 1.8 or less, more specifically, 1.0 to 1.8. According to an exemplary embodiment of the present invention, within the above range, the present invention may realize desired reflectance due to the difference in refractive index between the high refractive index layer and the low refractive index layer, and thus deep, soft and diverse colors may be excellently expressed.

In addition, the thickness of the low refractive index layer may be 70 nm or less, specifically, 3 to 70 nm, and more specifically, 3 to 60 nm. The laminated system may have a different reflectance at a surface or coating surface thereof according to the thickness of the low refractive index layer, and therefore, a color and sense of depth may vary. When the thickness of the low refractive index layer is more than 70 nm, since a desired reflectance or color in the present invention may not be realized, a high-quality color or transparency may be degraded.

In addition, in the laminated system, a high refractive index layer and a low refractive index layer, which have different refractive indexes, may realize soft and diverse colors due to the difference in refractive index between the layers and/or the difference in surface reflectance, but the mechanism of the present invention is not limited thereto.

For example, in the laminated system, the difference in refractive index between the high refractive index layer and the low refractive index layer may be 0.2 to 1.5, and specifically, 0.3 to 1.2. The laminated system including the high refractive index layer and the low refractive index layer, which satisfies the above-mentioned ranges, may satisfy a desired reflectance and color in the present invention, and specifically, a surface reflectance is 8 to 40%, the a* value of the color of the surface coating (laminated surface) is −5 to +5, and the b* value thereof is −10 to +10.

In addition, in the laminated system, the optical thicknesses of the high refractive index layer and the low refractive index layer may be important for realizing the above-mentioned range. Here, the optical thickness refers to the product of a refractive index and a physical thickness of each of the high refractive index layer and the low refractive index layer, which are isotropic optical elements, that is, the product (nd) of the refractive index (n) and the thickness of a medium (d).

In the present invention, the optical thickness of the low refractive index layer may be 3 to 100 nm, and specifically, 3 to 70 nm, and when the optical thickness of the low refractive index layer is more than 100 nm or less than 3 mm, a desired reflectance or color in the present invention may not be realized, and thus a high-quality color or transparency may be degraded.

In the present invention, the optical thickness of the high refractive index layer may be 6 to 180 nm, and specifically, 6 to 100 nm, and when the optical thickness of the high refractive index layer is more than 180 nm or less than 6 nm, since the desired reflectance or color in the present invention may not be realized, a high-quality color or transparency may be degraded.

In addition, when the laminated system according to the present invention is a multi-layered system, the thicknesses of each high refractive index layer and each low refractive index layer may be the same as, or different from each other. For example, a high refractive index layer, a low refractive index layer and a high refractive index layer, which all have a thickness of 20 nm, may be sequentially laminated on a substrate, or a high refractive index layer having a thickness of 15 nm, a low refractive index layer having a thickness of 13 nm, and a high refractive index layer having a thickness of 25 nm may be sequentially laminated on a substrate.

According to an exemplary embodiment of the present invention, in the laminated system, a material of the high refractive index layer satisfies a refractive index of 2.0 or more, and various materials may be used without inhibiting the effect of the present invention. The material of the high refractive index layer may include, for example, one or more materials selected from the group consisting of aluminum nitride, silicon nitride, silicon zirconium nitride, titanium oxide, zinc oxide, tin oxide, zirconium oxide, zinc-tin oxide, chromium oxide and niobium oxide. More specifically, the material of the high refractive index layer may include titanium oxide, silicon nitride or the like, and preferably, silicon nitride.

In addition, according to an exemplary embodiment of the present invention, in the laminated system, a material of the low refractive index layer satisfies a refractive index of 1.8 or less, and various materials may be used without inhibiting the effect of the present invention. The material of the low refractive index layer may include, for example, one or more materials selected from the group consisting of magnesium fluoride, aluminum oxide, silicon oxide, silicon oxynitride, silicon oxycarbide and a silicon-aluminum mixed oxide. More specifically, the material of the low refractive index layer may include silicon nitride, aluminum oxide or the like.

In addition, when the laminated system is a multi-layered system, the types of materials included as the materials of each high refractive index layer and each low refractive index layer may be the same as or different from each other in a range satisfying each refractive index.

According to an exemplary embodiment of the present invention, the surface reflectance of the laminated system may be 8 to 40%, and specifically, 8 to 30%. The surface reflectance, for example, the optical reflectance at a surface or coated surface at a wavelength range of 380 to 780 nm, may be measured using a spectrophotometric transmittance meter (model name: Lambda 950, Perkin Elmer). The color and sense of depth realized may vary according to the surface reflectance of the laminated system. When the surface reflectance of the laminated system is less than 8%, in terms of aesthetics, there may be a problem in realization of a ceramic texture, and when the surface reflectance of the laminated system is more than 40%, there may be a problem in realization of a soft color due to a high reflectance.

In addition, according to an exemplary embodiment of the present invention, in the laminated system, the color of the coating surface indicated by CIELAB color space coordinates at the observer angle of 10° may be represented as the a* value ranging from −5 to +5, and the b* value ranging from −10 to +10. In this range, deep and soft colors with a ceramic texture may be excellently realized.

In the laminated system, a method of laminated a high refractive index layer and a low refractive index layer on a substrate may be, for example, one or more selected from sputtering, evaporation, ion plating and chemical vapor deposition (CVD).

According to an exemplary embodiment of the present invention, various structures may be realized using the laminated system. For example, various structures may be realized as a means for applying or laminated various coating layers on a bottom and/or top surface(s) of the laminated system.

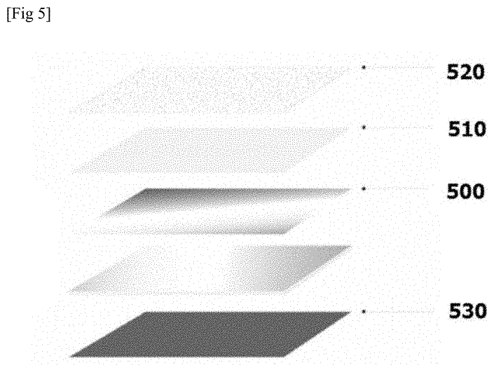

For example, as shown in FIG. 4, a structure which includes a single- or multi-layered laminated system 400 including a substrate and a high refractive index layer, a primer layer 410 including SiO₂ formed on the laminated system 400, and an anti-fingerprint coating film 420 may be realized.

In addition, as shown in FIG. 5, a structure which includes a single- or multi-layered laminated system 500 including a substrate and a high refractive index layer, a primer layer 510 including SiO₂ formed on the laminated system 500, an anti-fingerprint coating film 520, and various paint coating layers 530 formed on the bottom surface of the substrate may be realized. Here, the paint coating layer 530 may include, for example, one or more coating layers selected from a glass primer layer, a shielding layer, a shielding color layer, a UV layer and a shatter-resistant layer. As the various coating layers are included, a color or other physical effects may be achieved according to a desired purpose.

As the laminated system according to an exemplary embodiment of the present invention includes a refractive index layer satisfying a refractive index and a thickness in specific ranges, which is formed on a substrate, a transparent and soft color and a reflection effect may be exhibited, and thus the substrate may exhibit a deep and soft color with a ceramic texture or a luxurious texture. In addition, when the refractive index layer is used with a color paint coating composition applied on the bottom surface of the substrate, the color of the organic paint may be realized like a ceramic. Therefore, the laminated system may be effectively used in various purposes including mobile devices.

### EXAMPLES

<Manufacture of Laminated System>

### Example 1

A laminated system including a single-layered coating layer was obtained by laminating TiO₂ having a refractive index of 2.4 (ellipsometer) to a thickness of 50 nm on a glass substrate having a thickness of 0.5 mm through sputtering.

### Example 2

A laminated system including a multi-layered coating layer was obtained by sequentially laminating TiO₂ (high refractive index layer) having a refractive index of 2.4, SiO₂ (low refractive index layer) having a refractive index of 1.4 and TiO₂ (high refractive index layer) to respective thicknesses shown in Table 1 below on a glass substrate having a thickness of 0.5 mm through sputtering.

### Examples 3 to 6

A laminated system including a multi-layered coating layer was obtained in the same manner as in Example 2, except that the thicknesses of TiO₂ and SiO₂ were changed as shown in Table 1 below.

### Example 7

A laminated system including a multi-layered coating layer was obtained by sequentially laminating SiₓN_{y} (x=3, y=4, high refractive index layer) having a refractive index of 2.1, Al₂O₃ (low refractive index layer) having a refractive index of 1.7 and SiₓN_{y} (x=3, y=4, high refractive index layer) to respective thicknesses shown in Table 2 below on a glass substrate having a thickness of 0.5 mm through sputtering.

### Examples 8 and 9

A laminated system including a multi-layered coating layer was obtained in the same manner as in Example 7, except that the thicknesses of Si_{X}N_{y} and Al₂O₃ were changed as shown in Table 2 below.

### Comparative Examples 1 to 4

A laminated system including a multi-layered coating layer was obtained in the same manner as in Example 2, except that the thicknesses of TiO₂ and SiO₂ were changed as shown in Table 3 below.

### Comparative Examples 5 to 7

A laminated system including a multi-layered coating layer was obtained by sequentially laminating AZO (high refractive index layer) having a refractive index of 1.97, SnO (low refractive index layer) having a refractive index of 1.8 and AZO (high refractive index layer) to respective thicknesses shown in Table 2 below on a glass substrate having a thickness of 0.5 mm through sputtering.

### Comparative Examples 8 to 10

A laminated system including a multi-layered coating layer was obtained by sequentially laminating TiO₂ (high refractive index layer) having a refractive index of 2.4, SiₓN_{y} (x=3, y=4; low refractive index layer) having a refractive index of 2.1 and TiO₂ (high refractive index layer) to respective thicknesses shown in Table 5 below on a glass substrate having a thickness of 0.5 mm through sputtering.

### Comparative Examples 11 to 13

A laminated system including a multi-layered coating layer was obtained by sequentially laminating Al₂O₃ (high refractive index layer) having a refractive index of 1.7, SiO₂ (low refractive index layer) having a refractive index of 1.4 and Al₂O₃ (high refractive index layer) to respective thicknesses shown in Table 6 below on a glass substrate having a thickness of 0.5 mm through sputtering.

TABLE 1

| Thickness | | | Exam- | Exam- | Exam- | Exam- |
|---|---|---|---|---|---|---|
| (nm) | Example 1 | Example 2 | ple 3 | ple 4 | ple 5 | ple 6 |
| TiO₂ | — | 25 | 10 | 18 | 13 | 5 |
| SiO₂ | — | 13 | 13 | 35 | 50 | 30 |
| TiO₂ | 50 | 15 | 15 | 13 | 4 | 5 |

Glass (5T)
Refractive index: TiO₂ = 2.4, SiO₂ = 1.4

TABLE 2

| | Thickness (nm) | | |
|---|---|---|---|
| | Example 7 | Example 8 | Example 9 |
| Si₃N₄ | 30 | 30 | 10 |
| Al₂O₃ | 10 | 30 | 30 |
| Si₃N₄ | 30 | 10 | 30 |

Glass (5T)
Refractive index: Si₃N₄ = 2.1, Al₂O₃ = 1.7

TABLE 3

| | Thickness (nm) | | | |
|---|---|---|---|---|
| | Comparative | Comparative | Comparative | Comparative |
| | Example 1 | Example 2 | Example 3 | Example 4 |
| TiO₂ | 30 | 30 | 80 | 80 |
| SiO₂ | 80 | 10 | 10 | 80 |
| TiO₂ | 10 | 80 | 30 | 80 |

Glass (5T)
Refractive index: TiO₂ = 2.4, SiO₂ = 1.4

TABLE 4

| | Thickness (nm) | | |
|---|---|---|---|
| | Comparative | Comparative | Comparative |
| | Example 5 | Example 6 | Example 7 |
| AZO | 30 | 30 | 60 |
| SnO | 60 | 30 | 30 |
| AZO | 30 | 60 | 40 |

Glass (5T)
Refractive index: AZO = 1.97, SnO = 1.88

TABLE 5

| | Thickness (nm) | | |
|---|---|---|---|
| | Comparative | Comparative | Comparative |
| | Example 8 | Example 9 | Example 10 |
| TiO₂ | 30 | 60 | 30 |
| Si₃N₄ | 60 | 30 | 30 |
| TiO₂ | 30 | 30 | 60 |

Glass (5T)
Refractive index: TiO₂ = 2.4, SiO₂ = 2.1

TABLE 6

| | Thickness (nm) | | |
|---|---|---|---|
| | Comparative | Comparative | Comparative |
| | Example 11 | Example 12 | Example 13 |
| Al₂O₃ | 15 | 10 | 10 |
| SiO₂ | 65 | 65 | 70 |
| Al₂O₃ | 10 | 30 | 30 |

Glass (5T)
Refractive index: Al₂O₃ = 1.7, SiO₂ = 1.4

### Experimental Example

A reflectance and the color of a coating surface were measured using the single- or multi-layered laminated system obtained according to each of the examples and the comparative examples as follows, and the result is shown in Tables 7 to 12 below.

(1) Evaluation of Reflectance

The optical reflectance at the coating (surface) of the laminated system prepared in each of the examples and the comparative examples at a wavelength range of 380 to 780 nm was measured using a spectrophotometric transmittance meter (model name: Lambda 950, Perkin Elmer). The average value (Y) was obtained by multiplying the measured optical reflectance and the weighting function corresponding to AM1.5 according to the ISO 9050 standard.

(2) Coating Surface Color

CIELAB color space coordinates at the observer angle of 10° (CIE L*, CIE a*, CIE b*) represent values obtained according to F. W. Billmeyer, Jr., “Current American Practice in Color Measurement,” Applied Optics, Vol. 8, No. 4, pp. 737-750 (April 1969).

TABLE 7

| Reflectance | | Exam- | Exam- | Exam- | Exam- | Exam- |
|---|---|---|---|---|---|---|
| (%) | Example 1 | ple 2 | ple 3 | ple 4 | ple 5 | ple 6 |
| Y | 32.1 | 25.7 | 15.8 | 17.3 | 10.9 | 11.4 |
| L* | 63.5 | 57.8 | 46.7 | 48.6 | 39.4 | 40.3 |
| a* | −2.2 | −2.1 | −1.8 | −2.2 | −0.9 | −0.9 |
| b* | −5.1 | −6.0 | −1.8 | 0.6 | −1.8 | −4.3 |

TABLE 8

| | Reflectance (%) | | |
|---|---|---|---|
| | Example 7 | Example 8 | Example 9 |
| Y | 21.8 | 18.1 | 18.2 |
| L* | 53.8 | 49.7 | 49.7 |
| a* | −2.1 | −1.6 | −1.9 |
| b* | 3.7 | 0.3 | 3.7 |

TABLE 9

| | Reflectance (%) | | | |
|---|---|---|---|---|
| | Comparative | Comparative | Comparative | Comparative |
| | Example 1 | Example 2 | Example 3 | Example 4 |
| Y | 18.6 | 8.3 | 13.4 | 48.9 |
| L* | 50.3 | 34.6 | 43.3 | 75.4 |
| a* | 2.2 | 23.3 | 13.1 | −1.5 |
| b* | −24.8 | −34.9 | −25.9 | 60.5 |

TABLE 10

| | Reflectance (%) | | |
|---|---|---|---|
| | Comparative | Comparative | Comparative |
| | Example 5 | Example 6 | Example 7 |
| Y | 10.8 | 10.7 | 9.6 |
| L* | 39.3 | 39.1 | 37.2 |
| a* | 10.8 | 10.7 | 13.6 |
| b* | 0.3 | 2.3 | −14.2 |

TABLE 11

| | Reflectance (%) | | |
|---|---|---|---|
| | Comparative | Comparative | Comparative |
| | Example 8 | Example 9 | Example 10 |
| Y | 10.9 | 12.9 | 9.3 |
| L* | 39.4 | 42.6 | 36.5 |
| a* | 17.4 | 14.4 | 21.5 |
| b* | −38.8 | −33.2 | −39.4 |

TABLE 12

| | Reflectance (%) | | |
|---|---|---|---|
| | Comparative | Comparative | Comparative |
| | Example 11 | Example 12 | Example 13 |
| Y | 7.1 | 6.9 | 6.6 |
| L* | 32.1 | 31.6 | 30.8 |
| a* | −0.5 | 0 | 0.3 |
| b* | 0.4 | 4.4 | 4.1 |

All of the laminated systems obtained according to Examples 1 to 9 of the present invention satisfied a reflectance ranging from 8 to 40%, the a* value of the coating surface color was −5 to +5, and the b* value thereof was −10 to +10. On the other hand, the laminated systems of Comparative Examples 1 to 13 did not satisfy the above-mentioned ranges of the reflectance and coating surface color.

Specifically, in the laminated systems of Examples 2 to 6 manufactured by sequentially laminating TiO₂ (high refractive index layer) having a refractive index of 2.4, SiO₂ (low refractive index layer) having a refractive index of 1.4 and TiO₂ (high refractive index layer) to respective thicknesses of 70 nm or less on a glass substrate, the reflectance was approximately 10 to 26%, the a* value of the coating surface color was −3 to 0, and the b* value thereof was −6.0 to +0.6.

On the other hand, in the laminated systems of Comparative Examples 1 to 4 in which, although TiO₂, SiO₂ and TiO₂ were laminated on a glass substrate as in Examples 2 to 6, the thickness of at least one of the high refractive index layer and the low refractive index layer was more than 70 nm, it was confirmed that a reflectance and coating surface color values are out of the desired ranges of the present invention.

In addition, although having refractive indexes different from Examples 2 to 6, in the laminated systems of Examples 7 to 9 in which SiₓN_{y} (x=3, y=4; high refractive index layer) having a refractive index of 2.1, Al₂O₃ (low refractive index layer) having a refractive index of 1.7 and SiₓN_{y} (x=3, y=4; high refractive index layer) were laminated to respective thicknesses of 70 nm or less on a glass substrate, the reflectance was approximately 18 to 22%, the a* value of the coating surface color was −3 to 0, and the b* value thereof was 0 to +4.

However, when both the ranges of the high refractive index and the low refractive index were out of the scope of the present invention, that is, in Comparative Examples 5 to 7 in which AZO having a refractive index of 1.97, SnO having a refractive index of 1.88 and AZO were laminated, although each was laminated to a thickness of 70 nm or less, it was confirmed that the a* value of the coating surface color was out of the scope of the present invention, and both of the a* and b* values of the coating surface color in Comparative Example 7 were out of the scope of the present invention.

In addition, in Comparative Examples 8 to 10 in which each of the three layers implemented as a high refractive index layer was formed on the glass substrate to a thickness of 70 nm or less, it was confirmed that both of the a* and b* values of the coating surface color were out of the scope of the present invention.

In addition, in Comparative Examples 11 to 13 in which each of the three layers implemented as a low refractive index layer was formed to a thickness of 70 nm or less on a glass substrate, it was confirmed that both of the a* and b* values of the coating surface color satisfied the scope of the present invention, but the reflectance was less than 8% and in the range of 6.6 to 7.1%.

1. A laminated system, comprising:
a substrate; and
a high refractive index layer having a refractive index of 2.0 or more and a thickness of 70 nm or less, which is formed on the substrate.

2. The laminated system of claim 1, wherein a multi-layered coating layer including two or more layers is formed by laminating a low refractive index layer, which has a refractive index lower than that of a high refractive index layer, on the high refractive index layer, or repeatedly laminating the high refractive index layer and the low refractive index layer.

3. The laminated system of claim 2, wherein the low refractive index layer has a refractive index of 1.8 or less, and a thickness of 70 nm or less.

4. The laminated system of claim 2, wherein the difference in refractive index between the high refractive index layer and the low refractive index layer is 0.2 to 1.5.

5. The laminated system of claim 1, wherein the high refractive index layer has an optical thickness of 6 to 180 nm.

6. The laminated system of claim 2, wherein the low refractive index layer has an optical thickness of 3 to 100 nm.

7. The laminated system of claim 1, wherein the high refractive index layer comprises one or more materials selected from the group consisting of aluminum nitride, silicon nitride, silicon zirconium nitride, titanium oxide, zinc oxide, tin oxide, zirconium oxide, zinc-tin oxide, chromium oxide and niobium oxide.

8. The laminated system of claim 2, wherein the low refractive index layer comprises one or more materials selected from magnesium fluoride, aluminum oxide, silicon oxide, silicon oxynitride, silicon oxycarbide and a silicon-aluminum mixed oxide.

9. The laminated system of claim 2, wherein the outermost layer of the multi-layered coating layer is a high refractive index layer.

10. The laminated system of claim 1, wherein the surface reflectance of the laminated system is 8 to 40%.

11. The laminated system of claim 1, wherein, in the laminated system, the a* value of a color of the coating surface indicated by CIELAB color space coordinates for the observer angle of 10° is −5 to +5, and the b* value thereof is −10 to +10.

12. The laminated system of claim 1, wherein the substrate is formed of glass, polyethylene terephthalate (PET), or glass/PET.

13. The laminated system of claim 1, wherein the laminated system is formed by one or more methods selected from the group consisting of sputtering, evaporation, ion plating and chemical vapor deposition (CVD).
